(19) United States
(12) Patent Application Publication
(10) Pub. No.: US 2007/0070185 A1
(43) Pub. Date: Mar. 29, 2007

(54) System and method for remote display of security video images

(76) Inventors: Lady C. Dy, Chicago, IL (US); Clifford Kraft, Naperville, IL (US); Vasilios D. Dossas, Chicago, IL (US)

Correspondence Address: Clifford Kraft, 320 Robin Hill Dr., Naperville, IL, 60540, US

(21) Appl. No.: 11/236,242

(22) Filed: Sep. 27, 2005

(51) Int. Cl. H04N 7/14; H04N 7/18

(52) U.S. Cl. 348/14.03; 348/159

(57) ABSTRACT

A system and method for viewing video images from security systems on a remote handheld communications device like a cellular telephone. Video can be collected at a surveillance location, digitized and compressed, and streamed over a telephone line in a compressed form such as MPEG4 to a remote communications device. A menu on the remote device as well as a local joy-stick (or telephone navigation buttons) and other keys could allow selection of various cameras and/or pan, tilt and zoom functions on a particular camera. Split screen displays of more than one camera can be presented. In an alternative embodiment, the security video can be streamed from a web site.

### BACKGROUND

1. Field of the Invention

The present invention relates generally to the field of security video and more specifically to a system and method for the remote display of security video images.

2. Description of the Prior Art

Video cameras are frequently used in security systems. Normally cameras are placed in rooms of buildings, in warehouse and store ceilings and in various other locations to monitor activity in a particular area. Video cameras can also be placed in different rooms of residential structures such as homes to provide primary or secondary security.

Prior art systems generally route video signals from cameras to a monitoring site proximate to the surveillance area or at a remote location. Normally, several monitors are located at this site where guards or other personnel view them. Alternatively, or in addition, video from the cameras can be recorded for later replay. In some security systems, video is continuously recorded in a circular buffer that is saved when an alarm occurs.

It is also known in the art to stream commercial video or movies to a cellular telephone. However, it would be advantageous to be able to control and view images from security cameras on a remote handheld mobile device such as a cellular telephone.

### SUMMARY OF THE INVENTION

The present invention relates to a security system with video cameras that provide video surveillance of a predetermined residential or commercial area along with a control point for receiving video signals from each of the video cameras and a communications interface device for interfacing with the control point. The communications interface device generally receives command signals from a user where the command signals specify one or more of the video cameras as selected video cameras, and the control point supplies a transmission signal representative of at least one of the video signals to the communications interface device. The present invention can also include a hand-held mobile communication device remote from the control point that receives transmission signals from the communications interface device, selects particular video cameras from which the user wants to view images, and displays video images from at least one of the selected video cameras. The handheld mobile communications device can be a cellular telephone or any other portable communications device.

The present invention allows a remote user to dial in or otherwise connect with their residence or other protected building, area or asset and view real-time streamed video from security cameras on a handheld communications device like a cellular telephone. The user, by interfacing with a menu, can select and command up video from one or more of the cameras.

### DESCRIPTION OF THE FIGURES

FIG. 1 shows a security system that can relay video to a remote, handheld communications device.

FIG. 2 shows a block diagram of an embodiment present invention.

FIG. 3 shows a remote, handheld communications device with a split screen and menu displayed.

Several drawings and illustrations have been presented to better aid in the understanding of the present invention. The scope of the present invention is not limited to the embodiments shown in the drawings.

### DESCRIPTION OF THE INVENTION

The present invention relates to a system and method of displaying and controlling images from security systems on a remote, handheld communications device like a cellular telephone.

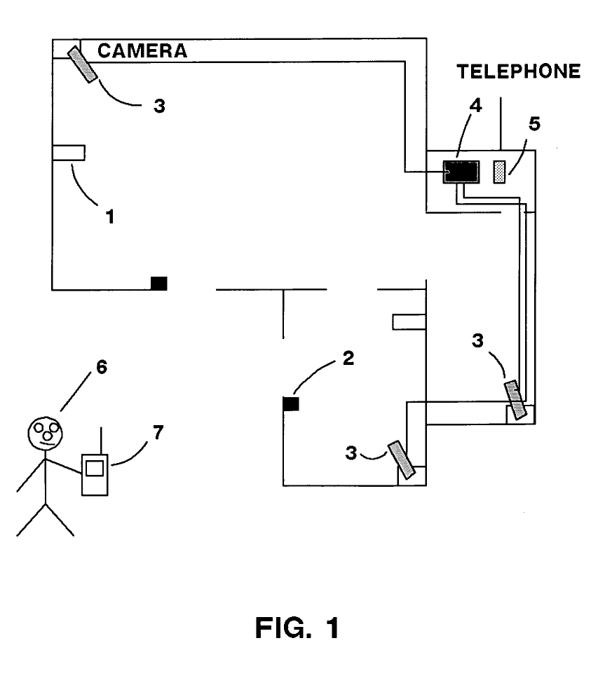

Turning to FIG. 1, a typical security system is shown for a residential location. Several motion detectors 1, access control switches 2 and video cameras 3 cover the surveillance area. In particular, each video camera produces a stream of continuous video that is wired back to a collection point 4 in the residence. The collection point 4 can be coupled to a telephone or other communications interface 5 that allows access to the public switched telephone network (PSTN) or access to a network or any other type of wired or wireless communications. A remote user 6 can command up display of video from any of the cameras 3 on a handheld communications device 7 such as a cellular telephone by calling a particular telephone number, accessing a particular web-site or by any other access method. While a residence is shown in FIG. 1, the present invention also relates to any type of area including, but not limited to, commercial buildings or locations such as office buildings, parking lots, restaurants or warehouses.

The collection point 4 can generally combine or switch the video. In addition, video may be compressed at this point. In one embodiment of the present invention, the collection point can act as a video compressor and switch so that various of the video feeds can be fitted into the bandwidth provided by a commercial telephone line. The telephone interface 5 can provide access to a regular telephone line (known as “plain old telephone service” POTS), or to a dedicated wider bandwidth service such as a T1 line, ISDN, fiber optic or other dedicated data service including a wireless service.

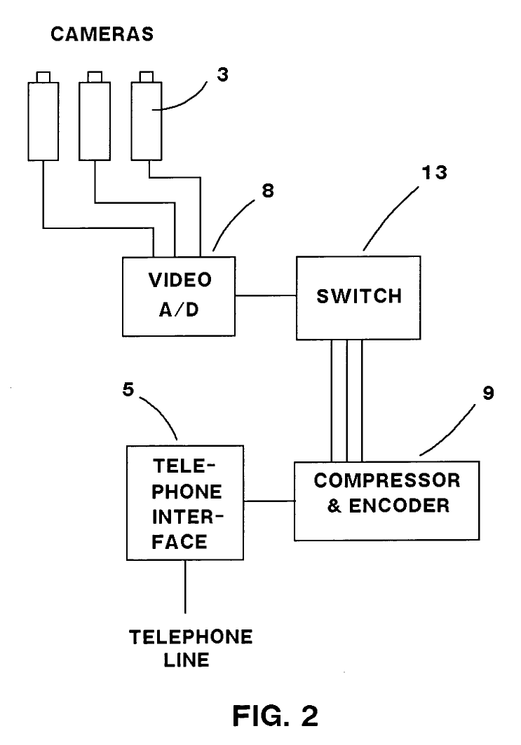

A block diagram of an embodiment of the present invention is shown in FIG. 2. Here several video feeds from cameras 3 can be combined and compressed so that they can be made available to leave the residence on a POTS or telephone line or otherwise. Black and white security camera video generally occupies a bandwidth of from around 2 to 5 MHz and is usually analog in nature. Several standard video formats are in general use including NTSC, PAL, SECAM, S-Video and RS-170 and others. The embodiment shown in FIG. 2 uses black and white cameras producing NTSC video with a bandwidth of around 5 MHz. Horizontal and vertical synchronization and blanking are contained in the NTSC signal according to the standard. While black and white is preferred because of possible lower bandwidth and greater simplicity in compression, color video and coding is within the scope of the present invention.

The 5 MHz video can be digitized by an A/D converter 8 as shown in FIG. 2 to produce a raw digital stream of 10-15 m-samples/sec. Each sample can contain from around 10-16 bits. For security work, samples can generally be smaller then in broadcast or multi-media arts. For example, the A/D converter 8 can produce a stream of digital samples or can be part of a more complex compression encoder. A video switch 13 can optionally be placed between the A/D converter 8 and the encoder 9 to select one or more particular cameras for encoding and subsequent transmission via the telephone or communications interface 5. FIG. 2 shows an MPEG4 encoder 9 coupled to the A/D converter 8 (MPEG standards are video and audio compression standards known in the art). Some MPEG encoders contain internal A/D converters and are supplied as a complete unit. While MPEG4 has been shown as the compression standard for the embodiment shown in FIG. 2, any compression method or standard is within the scope of the present invention including no compression at all (which could include, as a subset, low bit rate digital cameras or sampling cameras).

The MPEG4 standard is particularly designed for low data rate video streaming. It is based on the techniques of the MPEG1 standard with some advanced bandwidth reduction techniques. MPEG4 output can be adjusted to stream video into a telephone line modem at 50 kb/s. This works particularly well for security video because many times scenes are static for long periods of time.

In the preferred embodiment of the present invention, a remote user 6 with a cellular telephone or other communications device 7 can call the telephone number of the telephone interface 5, receive, or generate, a particular menu, and select one or more cameras to view (or alternatively view images from a single camera). Images in MPEG4 or other digital formats can then be streamed to the communication device. This allows a remote user to dial in to their residence or other protected asset and view live video from one or more cameras. The digital interface to the user can be controlled locally at the protected premises or from a central monitoring point. In FIG. 2, a user sends commands from his cellular telephone 7 to the telephone interface 5 stating which camera or cameras he wishes to view. The telephone interface 5 sends a command to the collection point 4 via a processor that causes the correct video feed or feeds to be compressed and transmitted to the remote unit. The user can then watch one or more images on his handheld communications device 7 for as long as desired.

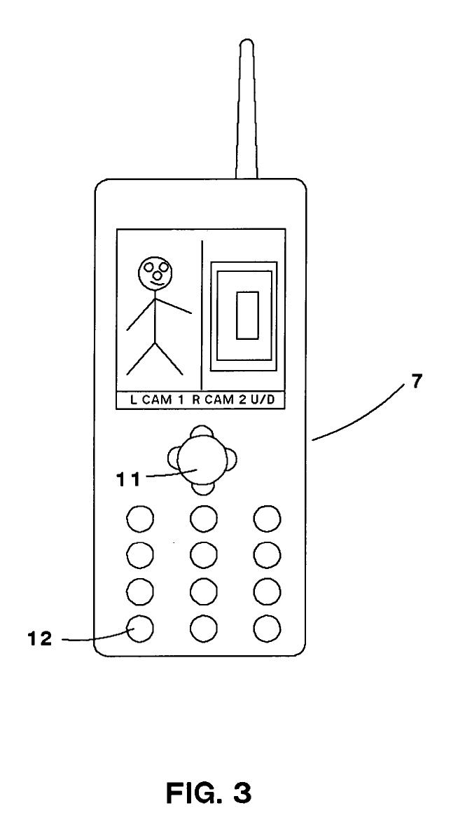

In the case of a cellular telephone, the handheld communications device 7 may be controlled by a mini-joystick 11 (as is known in the art of cellular telephones for left-right-up-down) to automatically select cameras or to send commands back to the collection point 4 to cause a particular camera to pan, tilt or zoom. A particular button 12 push could select a different security camera. A menu option could allow simultaneous, split-screen display of more than one camera. FIG. 3 shows a cellular telephone with a split screen display and navigation menu so that various button pushes can select cameras and the telephone joy-stick can cause camera movement and zooming.

In an alternate embodiment of the present invention, compressed video data can be streamed onto a web site where it could be made available to anyone with access to that site. In that case, a remote user with a cellular telephone or PDA would simply log onto the web site (gain authorized access) and then stream the video from the site server as is known in the art. Access control to the site could be by any of the generally known access control methods used in the site server art.

Several descriptions, illustrations and examples have been presented to better aid in understanding the present invention. One skilled in the art will realize that many changes and variations are possible. All of these changes and variations are within the scope of the present invention.

We claim:

1. A security system comprising:
a plurality of video cameras for providing video surveillance of a predetermined residential or commercial area;
a control point for receiving video signals from each of said video cameras;
a communications interface device interfacing with said control point, said communications interface device receiving command signals from a user, said command signals specifying one or more of said video cameras as selected video cameras;
said control point supplying a transmission signal representative of at least one of said video signals to said communications interface device;
a hand-held mobile communication device remote from said control point receiving said transmission signal from said communications interface device and displaying video from at least one of said selected video cameras.

2. The security system of claim 1 wherein said handheld mobile communications device is a cellular telephone.

3. The security system of claim 1 wherein said transmission signal is compressed.

4. The security system of claim 3 wherein said compression follows an MPEG standard.

5. The security system of claim 4 wherein said MPEG standard followed is MPEG4.

6. The security system of claim 1 wherein said remote, handheld communications device further contains a navigation device.

7. The security system of claim 6 wherein said navigation device is used to select images from particular cameras.

8. A method of providing remote video surveillance of a predetermined location comprising the steps of:
providing a plurality of video cameras configured to provide video surveillance of said location, each of said video cameras producing a video signal;
receiving command signals from a user remote from said video cameras using a handheld mobile communications device, said command signals specifying one or more of said video cameras as selected video cameras;
transmitting a signal representative of video signals from said selected cameras to said remote user, said remote user displaying video from at least one of said selected video cameras on said handheld mobile communications device.

9. The method of claim 8 wherein said handheld mobile communications device is a cellular telephone.

10. The method of claim 8 wherein said signal representative of signals from selected cameras is encoded.

11. The method of claim 10 wherein said encoding follows an MPEG standard.

12. The method of claim 11 wherein said MPEG standard is MPEG4.

13. The method of claim 8 wherein said handheld mobile communications device further contains a navigation device.

14. The method of claim 13 wherein said navigation device is used to select an image from a particular camera.

15. A method of remotely viewing video from a security site comprising the steps of:
providing a plurality of video cameras configured to provide video surveillance of said location, each of said video cameras producing a video signal;
transmitting a signal representative of a video signal from at least one of said cameras to a remote user, said remote user displaying video from at least one of said selected video cameras on a cellular telephone or PDA.

16. The method of claim 15 further comprising the step of receiving command signals from a user remote from said video cameras using said cellular telephone or PDA, said command signals specifying one or more of said video cameras as selected video cameras.

17. The method of claim 16 wherein a joystick device on said cellular telephone or PDA is used to specify one or more of said cameras for viewing.

18. The method of claim 15 wherein said signal representative of a video signal from at least one of said cameras is compressed.

19. The method of claim 15 wherein said signal representative of a video signal from at least one of said cameras is encoded.

20. The method of claim 19 wherein said signal is encoded according to an MPEG standard.
